(19) United States
(12) Patent Application Publication
(10) Pub. No.: US 2013/0262621 A1
(43) Pub. Date: Oct. 3, 2013

(54) Telecommunication system with variable functionality

(71) Applicants: Andrei Yoryevich Sherbakov, Moscow (RU); Oleg Olegovich Tikhonenko, Moscow (RU)

(72) Inventors: Andrei Yoryevich Sherbakov, Moscow (RU); Oleg Olegovich Tikhonenko, Moscow (RU)

(21) Appl. No.: 13/433,797

(22) Filed: Mar. 29, 2012

(51) Int. Cl. G06F 15/16

(52) U.S. Cl. 709/217

(57) ABSTRACT

The proposed system relates to communication and telecommunication fields, particularly to telecommunication systems with variable functionality. It can find useful applications in systems and networks for global and regional communication and data transmission, and significantly raise the reliability and protection of Internet segments. Comparing to known telecommunication systems, the proposed system differs with a possibility of easy development, increased control and scalability, and a capability of balancing the system's load. It can significantly enhance the efficiency of operation of telecommunication systems.

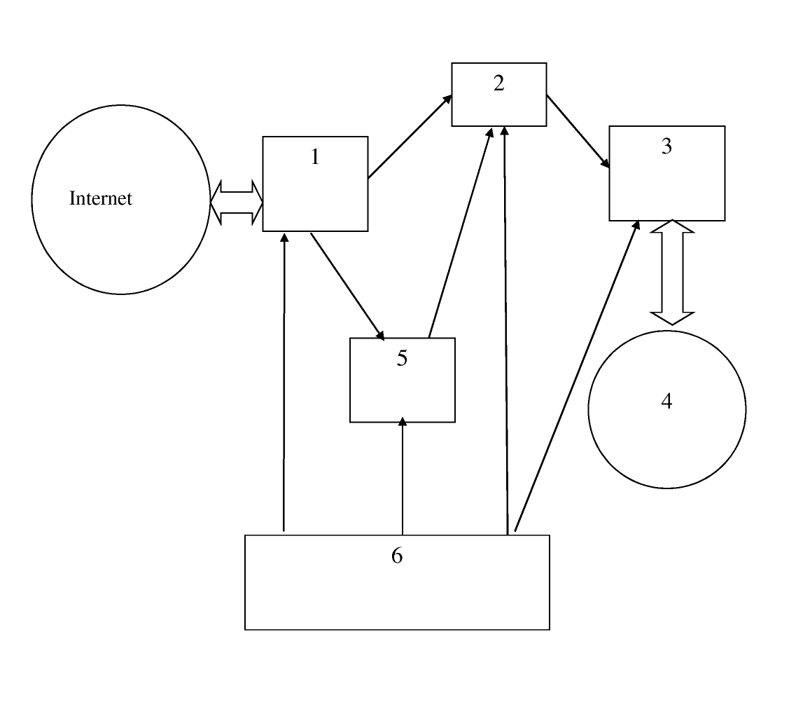

### FIELD OF THE INVENTION

The invention relates to the communication and telecommunication fields, particularly to telecommunication systems with variable functionality. The invention can find useful applications in systems and networks for global and regional communication and data transmission, and significantly raise the reliability and protection of Internet segments.

### BACKGROUND OF THE INVENTION

Nowadays, the computer hardware-software systems are characterized with further development of architecture of corporate networks. However, the improvement of routers and commutation equipment of the systems seems to be depleted. This is conditioned by the following problems in the development of such systems.

1) The flexible architecture and necessity of implementation of new business applications require continuous dynamic re-configuration and actualization of the communication infrastructure.

2) Balancing the load of certain components of a corporate network, under the requirement of strict routing and commutation, demands an additional furnishing of the systems with special equipment and manual tuning.

3) Effective implementation of new security products coming to the market encounters difficulties conditioned by static architecture of the communication equipment, and often by incompatibility of such new products and the equipment.

4) Operative troubleshooting of the known telecommunication systems is essentially complicated.

### AIMS AND BRIEF DESCRIPTION OF THE INVENTION

The instant inventors have formulated the following principles for building a communication system that may solve the aforementioned problems.

(1) Hardware computing resources of the communication system should provide a sufficient speed of calculations, which would be enough for processing the required amount of data traffic. This capability is herein called a ‘high computing power resource’ of the communication system.

(2) The hardware resources should be enabled to be augmented within a particular system, i.e. there should be provided a possibility of adding necessary units within one casing. This capability is herein called a ‘scalability’ of the communication system.

(3) The operating system of the communication system should be universal and widely spread to provide operation and portability of a sufficient plurality of communication and utility applications and a universal interface for interoperability of system components. This capability is herein called a ‘universal-ability’ of the communication system.

(4) The communication system should preferably be built on an ‘open-code’ principle, to reduce the number of threats, allow for verification and increasing trust, as well as for enabling of user own development and maintenance. This capability is herein called ‘openness’ (open architecture) of the communication system.

(5) The communication system should be equipped with balancer means, i.e. there should be a possibility of integrating modules, controlling the load of components and augmented units, into the system. This capability is herein called ‘balance-ability’ of the communication system.

(6) Effective measures should be implemented for increasing the reliability and reparability of the communication system. Herein, this is called ‘reliability and reparability’ of the communication system.

Compliance with the above enumerated principles provides for automatically enhancing important properties of communication systems, such as:
stability (sustainability) as to attacks of the ‘service denial’ type due to a sufficiently high computing power resource (principle 1 above) and balance-ability of the communication system (principle 5 above);
a capability of integration of communication applications and security means due to universal-ability and openness of the system (principles 3-4);
a capability of using any external means for control of integrated applications and security means.

Therefore, the primary aim of the present invention is to create an improved telecommunication system being essentially free of the aforesaid shortcomings of known telecommunication systems. Other aims can however be discovered by those skilled in the art upon learning the present disclosure.

According to a preferred embodiment of the present invention, a telecommunication system with variable functionality is provided, which telecommunication system is intended for data transmission between at least two computer systems via external data transmission networks; the telecommunication system comprises:
at least one communication module receiving and/or transmitting data from external data transmission systems and computer systems and/or into external data transmission networks and computer networks;
at least one computing module processing and/or converting received data and distributing the processed/converted data between telecommunication modules; and
at least one control module coordinating the operation of the at least one communication module and the at least one computing module;
   wherein the operation of at least a portion of the communication, computing, and control modules is provided based on algorithms capable of modification.

According to a preferred embodiment of the present invention, it is expedient to provide that the at least one communication module be suitable for wireless connection.

For providing a quality control of the telecommunication system, according to a preferred embodiment of the present invention, it is expedient to envisage a modification of function algorithms, of at least some of the communication, computing, and control modules, which modification is conducted upon commands received from the external data transmission networks, or from the computer systems exchanging the data therebetween.

For providing a safe control of the telecommunication system, according to a preferred embodiment of the present invention, it is expedient, upon conducting the modification of the function algorithms, to set up an authorization requirement for the operator and/or for a computer program providing the modification, as well as to implement a log of modifications within the telecommunication system or in one of the computer systems.

For providing a safe data transmission in the telecommunication system, and for safety of confidential data, according to a preferred embodiment of the present invention, it is expedient encoding the data transmitted between the communication modules. For providing an optimal traffic in the telecommunication system, it is expedient enabling the control modules for optimal distribution of transmitted and received data.

For providing an optimal implementation, maintenance, and technical support of the telecommunication system, it is expedient integrating all the modules in one device.

For providing a reliable data transmission it is expedient incorporating a data storage unit into the telecommunication system, so that the data might be placed therein before and after processing thereof in the computing module.

For providing control of data of the telecommunication system, according to a preferred embodiment of the present invention, it is expedient implementing an anti-virus control of the received and / or transmitted data, as well as enabling the telecommunication system to function as a firewall.

### BRIEF DESCRIPTION OF DRAWING

A preferred embodiment of the present invention is illustrated on attached FIGURE that shows a schematic flowchart of the inventive system.

### DETAIL DESCRIPTION OF PREFERRED EMBODIMENTS OF THE INVENTION

While the invention may be susceptible to embodiment in different forms, there are shown in the drawings, and will be described in detail herein, specific embodiments of the present invention, with the understanding that the present disclosure is to be considered an exemplification of the principles of the invention, and is not intended to limit the invention to that as illustrated and described herein.

A preferred embodiment of the present invention is illustrated on FIGURE attached hereto, which shows a flowchart depicting a point of access (also called an ‘access point’ herein below) to the Internet that provides for anti-virus control of receiving data.

The access point is represented by a device that comprises the following units:
a communication module 1, receiving and transmitting data from an external network, in this case being the Internet, the communication module 1 is characterized with its own function algorithms;
a communication module 3 characterized with its own function algorithms, the communication module 3 receives data from and transmits data to
a local network 4;
a computing module 2 characterized with its own function algorithms, the computing module 2 executes the processing and conversion of the received and/or transmitted data and redistribution thereof between the modules 1 and 3;
an antivirus control computing module 5;
a control module 6 characterized with its own function algorithms, the control module 6 coordinates functioning the communication modules 1 and 3, and the computing module 2;
   whereas function algorithms of the modules 1 and 3 and the computing module 2 are modified depending upon a control result obtained from the antivirus module 5, which receives antivirus updates from the Internet via the module 1.

The modification of function algorithms is conducted by an alteration of receiving data packets as follows: when the system receives virus-infected objects from a source having an IP-address, this IP-address is stored in the module 5, and transmitted into the module 1, wherein an instruction is generated to prohibit the reception of data packets from the IP-address. Additionally, the module 1 receives algorithm updates for data packet routing from the network, which updates prescribe an updated routing from the module 1 to the module 3 through changes of the function algorithms of modules 1, 2, and 3.

The aforesaid changes of function algorithms of modules 1, 2, and 3 are determined by a list of addresses, which addresses belong to sources of data infected by a computer virus. If a data packet is received from an address contained in the list, then the module 2 issues an instruction prohibiting a passage of the packet from the module 1 to the module 3. The address list is constantly updated upon receipt of new anti-virus bases based on anti-virus tests of corresponding objects, conducted by the module 1. If a data packet is received from a source, and the data packet contains a virus, the source's address is placed in the aforementioned address list.

In comparison with the known telecommunication systems, the inventive system is distinct by its development capability, enhanced control and scalability, capability of load balancing, which may result in a higher efficiency of operation of the system.

We claim:

1. A telecommunication system with variable functionality for data transmission between at least two computer systems via external data transmission networks; said telecommunication system comprises:
at least one communication module capable of receiving and/or transmitting data from/to said external data transmission networks, and/or said at least two computer systems, said at least one communication module is characterized with predetermined communication functionalities and function algorithms;
at least one computing module capable of processing and/or converting received and/or converted data, said at least one computing module is characterized with predetermined computing functionalities and function algorithms; and
at least one control module, capable of coordinating the predetermined said communication and said computing functionalities, said at least one control module is characterized with control function algorithms;
wherein the function algorithms of at least some of said at least one communication, computing, and control modules can be modified.

2. The telecommunication system according to claim 1, wherein said at least one communication module provides for wireless connection.

3. The telecommunication system according to claim 1, wherein the modification of said function algorithms of at least some of said at least one communication, computing, and control modules is conducted upon commands received from said external data transmission networks, or from said at least two computer systems exchanging data therebetween.

4. The telecommunication system according to claim 3, wherein, upon conducting said modification, an authorization requirement is set up for an operator and/or for a computer program providing the modification.

5. The telecommunication system according to claim 3, wherein a log of modifications is implemented within the telecommunication system or in one of said at least two computer systems.

6. The telecommunication system according to claim 1, wherein at least one communication module comprises at least two communication modules, and encoding the data transmitted between the at least two communication modules is provided.

7. The telecommunication system according to claim 1, wherein said at least one control module optimally distributes data transmitted or received.

8. The telecommunication system according to claim 1, wherein said at least one communication, computing, and control modules are integrated into one device.

9. The telecommunication system according to claim 1, further comprising a data storage unit, such that before or after processing data in said at least one computing module, the data can be placed into said data storage unit.

10. The telecommunication system according to claim 1, wherein an anti-virus control of the received and/or transmitted data is implemented.

11. The telecommunication system according to claim 1, wherein the telecommunication system is capable of functioning as a firewall.

12. The telecommunication system according to claim 1, wherein at least one communication module comprises at least two communication modules, and said telecommunication system is capable of re-distribution received and/or converted data between said at least two communication modules.

13. A telecommunication system with variable functionality for data transmission between at least two computer systems via external data transmission networks; said telecommunication system comprising at least one access point, said at least one access point includes:
a local network (4);
a communication module (1), receiving data from and transmitting data to said external networks, and characterized with communication function algorithms;
a communication module (3) characterized with communication function algorithms, the communication module (3) is associated with at least the local network (4);
a computing module (2) characterized with computing function algorithms, the computing module (2) receives data from and transmits data to the communication module (3), and executes processing and conversion of the received and/or transmitted data and redistribution thereof between the modules (1) and (3);
an antivirus control computing module (5) associated at least with the communication modules (1) and (2);
a control module (6) characterized with control function algorithms, the control module (6) coordinates functioning the communication modules (1) and (3) and the computing module (2), the control module (6) is associated with at least the antivirus control computing module (5);
wherein said communication function algorithms of the communication modules (1) and (3) and said computing algorithms of the computing module (2) are subjected to a modification depending upon a control result obtained from the antivirus module (5), while said antivirus module (5) receives antivirus updates from said external data transmission networks via the communication module (1).

14. The telecommunication system according to claim 13, wherein said modification is conducted as follows:
upon receiving virus-infected objects by the telecommunication system from a source having an IP-address, storing said IP-address in the antivirus control computing module (5), and transmitting thereof into the communication module (1);
generating an instruction to prohibit any further reception of data packets from said IP-address; and
receiving algorithm updates for data packet routing by the communication module (1) from the external data transmission networks, said algorithm updates prescribe an updated routing from the communication module (1) to the communication module (3) through changes of the function algorithms of said modules (1), (2), and (3).

15. The telecommunication system according to claim 14, wherein said changes of the function algorithms of said modules (1), (2), and (3) are conditioned by an address list of IP-addresses of sources of data infected by a computer virus;
said address list is constantly updated upon receipt of new anti-virus bases based on anti-virus tests of corresponding objects, conducted by the communication module (1); and
wherein, upon receipt of a data packet from an address contained in the address list, the computing module (2) issues an instruction prohibiting a passage of the data packet from the communication module (1) to the communication module (3).
